(19) United States
(12) Patent Application Publication
(10) Pub. No.: US 2022/0112946 A1
(43) Pub. Date: Apr. 14, 2022

(54) SPILL PROOF DRAIN PLUG

(71) Applicant: Richard Meggitt, Spooner, WI (US)

(72) Inventor: Richard Meggitt, Spooner, WI (US)

(21) Appl. No.: 17/315,173

(22) Filed: May 7, 2021

Related U.S. Application Data
(60) Provisional application No. 63/089,784, filed on Oct. 9, 2020.

(51) Int. Cl. F16H 57/04; B63H 23/02; F16N 31/00; F16K 15/04

(52) U.S. Cl. CPC F16H 57/0408; B63H 23/02; F16N 2031/008; F16K 15/044; F16N 31/00

(57) ABSTRACT

A port insert for a marine lower unit includes a hollow body having a first end and a second end, the second end having a first exterior thread configured to couple with a cap and one or more apertures formed in the body adjacent the first end. The port insert also includes a spring mechanism disposed within the hollow body. The port insert further includes a sealing member coupled to the spring mechanism, the sealing member being biased toward the second end in a non-use state.

### REFERENCE TO RELATED APPLICATIONS

This application claims priority to U.S. Provisional Application No. 63/089,784, filed on Oct. 9, 2020, to inventor Richard Meggitt, the entirety of which is herein incorporated by reference.

### BACKGROUND

Both outboard boat motors and inboard/outboard boat motors may include a marine lower unit or lower gear unit which generally resides partially below the water level during use. Regular maintenance of the marine lower unit includes, most notably, changing of the gear oil which is disposed in the interior of the lower unit. Conventionally changing of the gear oil is a messy process. In most maintenance situations, gear oil spillage is unavoidable because of the lower unit Drain/Fill port and plug design. The lower unit servicing procedure requires the draining and pumping of gear oil through a combination Drain/Fill port. The plug consists generally of a threaded cap sealing a circular drain and fill aperture. Upon plug removal by a servicer, gear oil spills out, onto the service persons hand and down the side of the lower unit creating a mess of dirty oil that must be cleaned up. To fill the lower unit a pump, that incorporates a hose with a threaded fitting on the end of it, screws into the lower unit Drain/Fill port. At the conclusion of filling the lower unit, the pump fitting must be removed, and the drain/fill plug installed. As the pump fitting is removed gear oil pours out the plug opening while the service person struggles to screw the plug back in place. This process is messy and because of the spillage can also create a low oil condition.

### SUMMARY OF THE INVENTION

An exemplary embodiment is directed to a port insert. The port insert includes a hollow body having a first end and a second end, the second end having a first exterior thread configured to couple with a cap and one or more apertures formed in the body adjacent the first end. The port insert also includes a spring mechanism disposed within the hollow body. The port insert further includes a sealing member coupled to the spring mechanism, the sealing member being biased toward the second end in a non-use state.

In one exemplary embodiment a port insert system includes a port insert. The port insert includes a hollow body having a first end and a second end, the second end having a first exterior thread configured to couple with a cap, one or more apertures formed in the body adjacent the first end, a spring mechanism disposed within the hollow body, and a sealing member coupled to the spring mechanism, the sealing member being biased toward the second end in a non-use state. The port insert system also includes a draining member configured to be coupled to a drain tube, the draining member configured to fit at least partially within the hollow body.

In another exemplary embodiment a boat motor includes a marine upper unit including a torque generator and a boat propeller. The boat motor also includes a marine lower unit comprising a gear system transferring torque generated by the torque generator to the boat propeller. The marine lower unit is configured to contain a volume of oil and a draining and filling port having a spring biased valve preventing oil from flowing out of the draining and filling port in a non-use state.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The port insert may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE FIGURES

FIG. 1 is a perspective view of an illustrative embodiment of a marine lower unit having an oil fill and drain port.

FIG. 2 is perspective view of an illustrative embodiment of a port insert having a ball valve.

FIG. 3 is a cut away perspective view of the port insert of FIG. 2.

FIG. 4 is a cut away perspective view of the marine lower unit of FIG. 1 having the port insert of FIG. 2

FIG. 5 is a cross sectional view of the port insert of FIG. 2 depicting the port insert in use for draining and for filling.

FIGS. 6-11 are various views of illustrative embodiments with varied configurations in accordance with the subject matter described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The subject matter presented is directed to a spill proof drain plug that enables a simplified and neater process when draining and refilling the gear oil in the lower unit of a marine drive system by preventing gear oil spillage while enabling an accurate fill level.

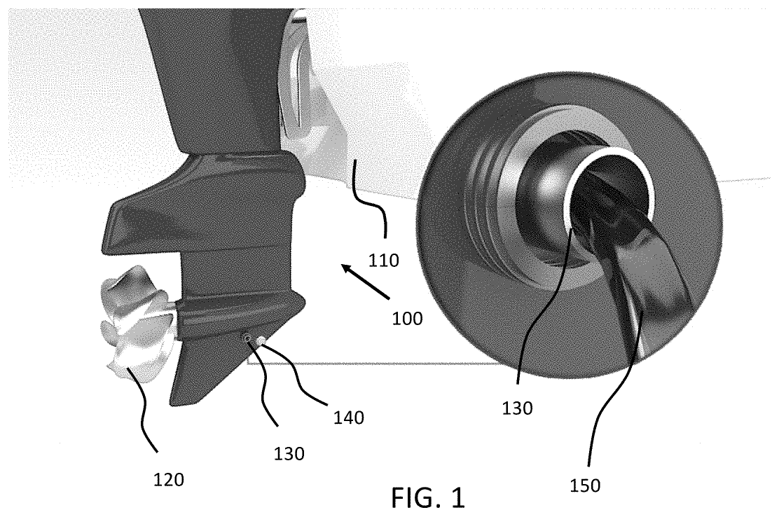

Referring now to FIG. 1, a marine lower unit 100 is depicted. Marine unit 100 is representative of a lower unit of either an outboard motor or the lower unit of an inboard outboard motor. Marine lower unit 100 is coupled to a boat 110. Marine lower unit 100 contains within, a gear unit configured to drive a propeller 120. Gears within the lower unit require gear oil which is contained therein. During use the gear oil becomes contaminated with both particle grit, water, or both. Therefore, the contaminated gear oil requires periodic draining from the lower unit and replaced with clean oil. A drain and fill port 130 allows for draining of the lower unit 100. Generally, drain and fill port 130 is closed with a plug cap 140 that is threaded for fitting onto drain and fill port 130. As plug cap 140 is removed from drain and fill port 130, oil 150 begins pouring out of port 130, with nothing to prevent it from running onto the technician's hand or tool as the plug is unscrewed and the oil runs out uncontrolled.

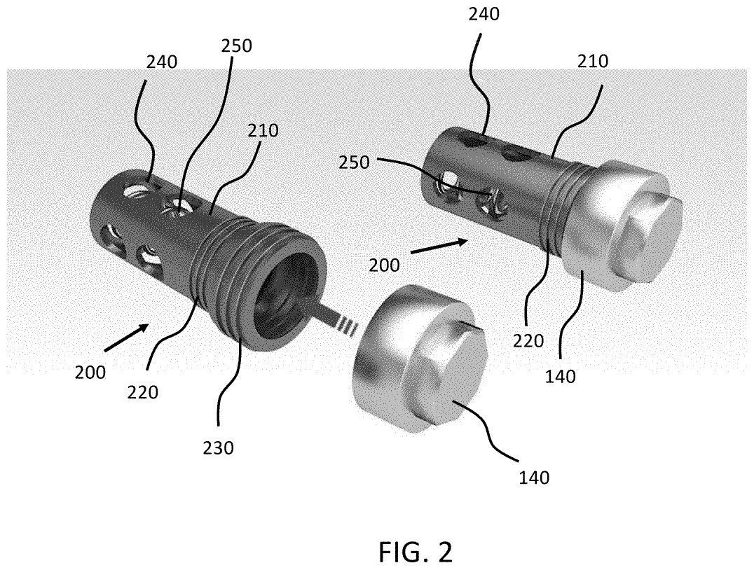

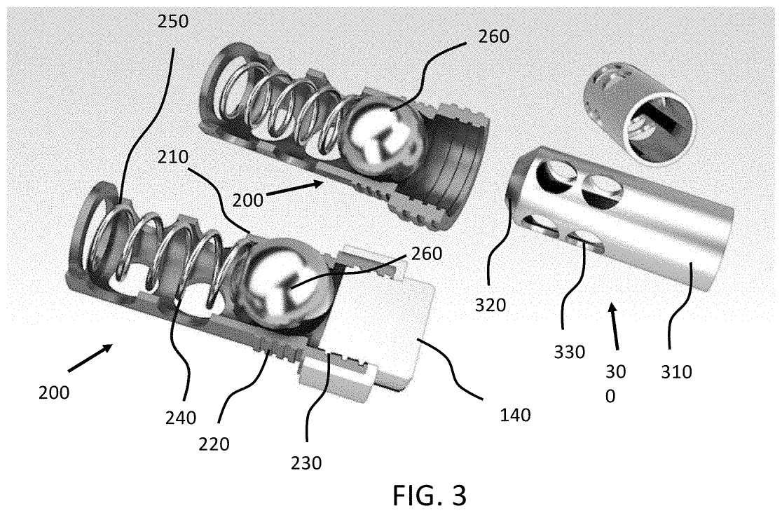

Referring now to FIG. 2, a port insert 200 includes a cylindrical body 210 configured to fit concentrically within a standard drain and fill port. Cylindrical body 210 includes a thread 220 configured to engage with an internal thread of the drain and fill port. A second thread 230 is configured to engage a drain and fill port cap 140, such as but not limited to a standard drain and fill port cap. In various embodiments, the port insert 200 is a retrofit insert for a standard drain and fill port or can be sized for any of a variety of drain and fill ports. Cylindrical body 210 also includes one or more apertures 240 through which gear oil may flow. In the interior of cylindrical body 210 resides a spring 250 that biases a seal, such as but not limited to a ball bearing seal 260 as depicted in FIG. 3. In the biased position, depicted in FIG. 3, cap 140 may be removed such that ball bearing seal 260 is configured to seal the opening such that no oil escapes through the port.

When draining of the lower unit is desired a draining tip 300 is used. Draining tip 300 includes a cylindrical body 310 that substantially fits concentrically into the interior of cylindrical body 210. Draining tip 300 also includes a beveled tip 320 and one or more draining apertures 330. Draining tip 300 may desirably be coupled to a hose, at the end opposite beveled tip 320, through which used oil may be drained through.

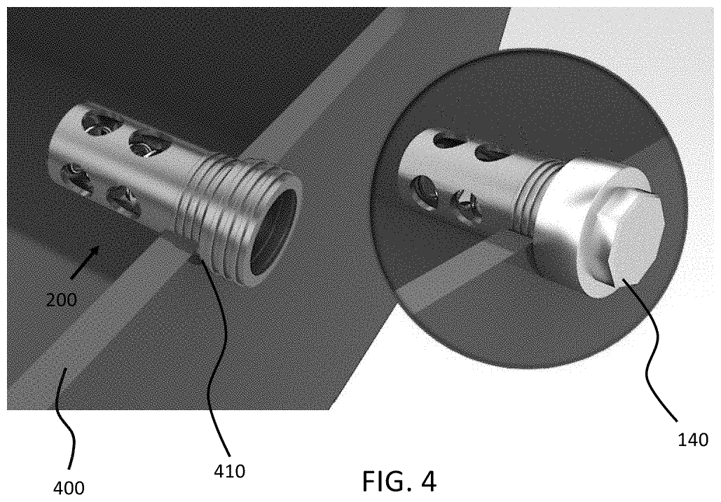

Referring now to FIG. 4, a cutaway of a wall of a marine lower unit 400 is depicted, to show an embodiment of the port insert 200 engaged with a fill and drain port 410. Once installed as a retrofit to marine lower unit 400 or installed as original equipment, a conventional cap plug 140 may be used to close and seal the drain and fill port 410.

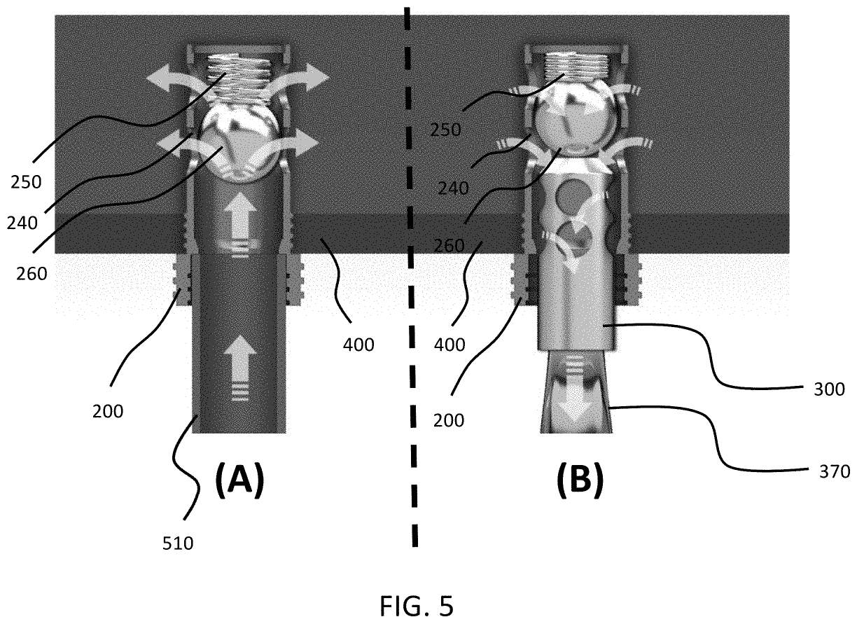

Referring to FIG. 5, a situation in which marine lower unit 400 is being filled is exemplified by the diagram marked (A) and a situation in which the marine lower unit is being drained is the diagram marked (B). It should be noted that the diagrams (A) and (B) represent the same drain and fill port having port insert 200 coupled thereto. As can be seen in diagram (A), a filling conduit 510 is coupled to port insert 200. Oil is pumped through filling conduit 510 under sufficient pressure to compress spring 250, thereby opening the seal that had been created by ball bearing seal 260. This oil pressure effectively opens the valve created by ball bearing 260 and spring 250 so that oil may flow into the marine lower unit 400 through apertures 240.

Diagram (B) depicts the draining tip 300 being inserted into the port insert 200 in so doing engages the ball bearing seal 260 and compresses spring 250. In the depicted state, oil may drain through apertures 240 into the interior of draining tip 300 and through a drain hose 370 which is coupled to draining tip 300.

The port insert 200 generally incorporates a control valve, a plunger, a diaphragm, or, for this example, a ball spring. The port insert 200 may be a direct retro fit by sharing the same dimension and thread size as the lower unit drain port. As discussed, draining the Lower Unit may be done by unscrewing a plug cap and screwing in the draining tip which pushes the sealing ball to a position that allows gear oil to flow out of the lower unit. A flexible tube may be coupled to the draining tip to direct the used gear oil into a receptacle. Filling the Lower Unit may be done by unscrewing the plug cap and screwing in the hose fitting of a marine gear oil pump. The pumping of gear oil pushes the sealing ball to a position that allows gear oil to flow into the lower unit. When the lower unit reaches its full level, the operator stops pumping; this causes the sealing ball to move to the closed position. The pump fitting may then be removed, and the plug cap may be replaced.

The exact size, measurement, construction, and design specifications may vary upon further development and manufacturing. What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

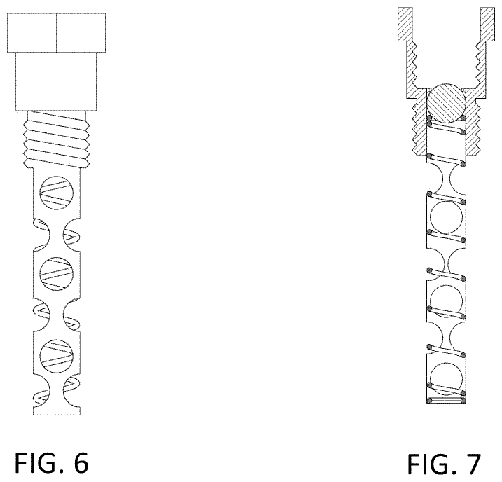

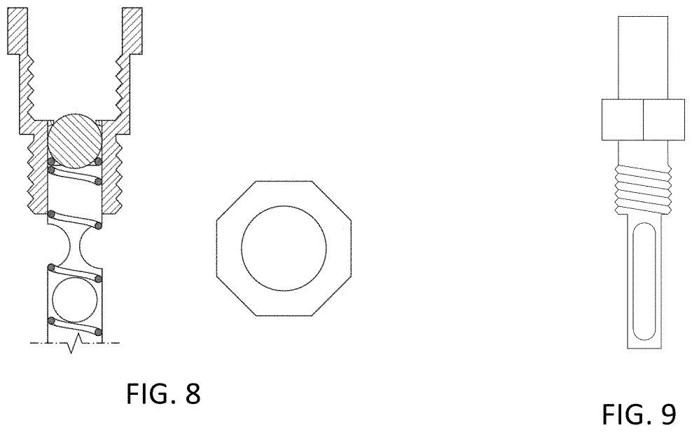

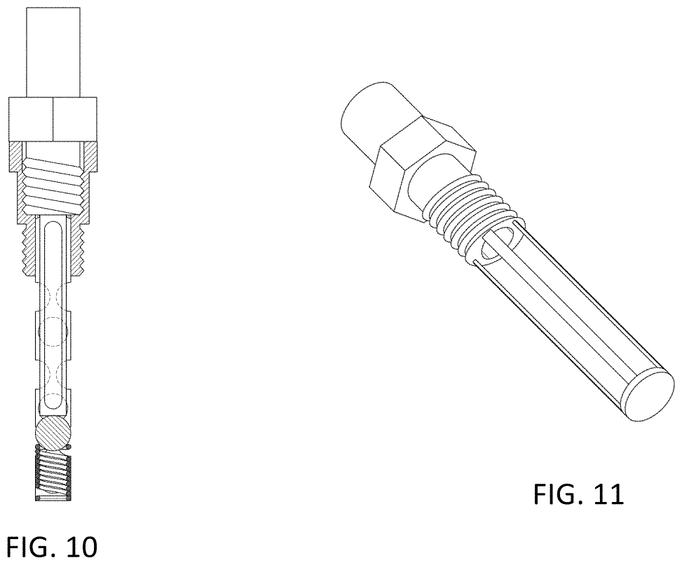

FIGS. 6-11 are various views of illustrative embodiments with varied configurations in accordance with the subject matter described herein. The various illustrative embodiments enable the substantially same functionality as the embodiments discussed above.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A port insert, comprising:
a hollow body having a first end and a second end, the second end having a first exterior thread configured to couple with a cap;
one or more apertures formed in the body adjacent the first end;
a spring mechanism disposed within the hollow body; and
a sealing member coupled to the spring mechanism, the sealing member being biased toward the second end in a non-use state.

2. The port insert of claim 1, further comprising:
a second external thread located between the first external thread and the one or more apertures.

3. The port insert of claim 2, wherein the second external thread is configured to engage with a thread of a drain port of a marine lower unit.

4. The port insert of claim 1, further comprising:
an internal thread within the hollow body adjacent the second end.

5. The port insert of claim 1, wherein the hollow body includes a substantially cylindrical body.

6. The port insert of claim 1, wherein the sealing member includes a ball bearing.

7. The port insert of claim 1, wherein the sealing member includes a semi-spherical member.

8. The port insert of claim 1, wherein the spring mechanism includes a helical spring.

9. The port insert of claim 1, wherein the spring mechanism includes a leaf spring.

10. The port insert of claim 1, wherein the one or more apertures includes six apertures.

11. A port insert system, comprising:
a port insert, the port insert including:
a hollow body having a first end and a second end, the second end having a first exterior thread configured to couple with a cap;
one or more apertures formed in the body adjacent the first end;
a spring mechanism disposed within the hollow body; and
a sealing member coupled to the spring mechanism, the sealing member being biased toward the second end in a non-use state; and
a draining member configured to be coupled to a drain tube, the draining member configured to fit at least partially within the hollow body.

12. The port insert system of claim 11, further comprising:
a second external thread located between the first external thread and the one or more apertures.

13. The port insert system of claim 12, wherein the second external thread is configured to engage with a thread of a drain port of a marine lower unit.

14. The port insert system of claim 11, further comprising:
an internal thread within the hollow body adjacent the second end.

15. The port insert system of claim 11, wherein the hollow body includes a substantially cylindrical body.

16. The port insert system of claim 11, wherein the sealing member includes a ball bearing.

17. The port insert system of claim 11, wherein the sealing member includes a semi-spherical member.

18. The port insert system of claim 11, wherein the spring mechanism includes a helical spring.

19. The port insert system of claim 11, the draining member includes a conduit having a first end aperture, a second end aperture and one or more apertures along the conduit.

20. A boat motor, comprising:
a marine upper unit including a torque generator;
a boat propeller;
a marine lower unit comprising a gear system transferring torque generated by the torque generator to the boat propeller, the marine lower unit configured to contain a volume of oil and a draining and filling port having a spring biased valve preventing oil from flowing out of the draining and filling port in a non-use state.
